(19) United States
(12) Patent Application Publication
(10) Pub. No.: US 2015/0070835 A1
(43) Pub. Date: Mar. 12, 2015

(54) MODULAR DOCKING STATION

(71) Applicant: MerchSource, LLC, Irvine, CA (US)

(72) Inventor: Kirk Ian Mclean, Fullerton, CA (US)

(21) Appl. No.: 14/480,391

(22) Filed: Sep. 8, 2014

Related U.S. Application Data
(60) Provisional application No. 61/874,714, filed on Sep. 6, 2013.

(51) Int. Cl. G06F 1/16; H02J 7/00

(52) U.S. Cl. CPC G06F 1/1632; G06F 1/1688; G06F 1/1637; G06F 1/1684; H02J 7/0044
USPC 361/679.41

(57) ABSTRACT

This invention provides a modular docking station for mobile devices that allow the mobile device to connect to the modular docking station by an interchangeable mount device that are specifically associated with a particular mobile devices. A user can easily swap out the specific mobile device interfaces such that the mobile station can support multiple types of mobile devices. A large display screen on the modular docking station allows users to replicate the screen on the mobile device and allows for capacitive touch such that the gestures used on the mobile device's screen will act the same way when the user touches the screen on the modular docking station. Loudspeakers and a more sensitive microphone integrated into the modular docking station can transform the relatively poor speaker phone capabilities of the mobile device into a commercial grade speaker phone.

### CLAIM OF PRIORITY

This application claims priority to U.S. Provisional Patent Application No. 61/874,714 filed on Sep. 6, 2013 titled “Modular Docking Station” and is incorporated by reference in its entirety.

### BACKGROUND OF THE INVENTION

1. Field of the Invention

The invention relates to a modular docketing station and, in particular, a docketing station that is able to utilize existing sync and charging cables for various device interfaces.

2. Related Art

Docking stations exist that interface with mobile devices for recharging and improving the audio fidelity of the mobile device when music is played. However, a need exists for a device that can recharge the mobile device while also providing users will poorer eye sight the ability to see a larger screen for manipulating the gestures required for controlling the mobile device's functionality. Also there is a need for a device that can transform the mobile device into a commercial grade speaker phone.

### SUMMARY

This invention provides a modular docking station for mobile devices that can connect to the modular docking station via an interchangeable mount device that are associated with a particular mobile devices (e.g., power and data connections that are unique with each mobile device types). For example, an iPhone 4s has an interface supporting data and electric recharging that differs from an iPhone 5 and Android mobile devices. A user can easily swap out the specific mobile device interfaces such that the mobile station can support multiple types of mobile devices.

Inclusion of a large display screen on the modular docking station allows users with poor eyesight to increase the size of icons, numbers and other items displayed on the mobile device screen which is substantially smaller in size. This larger display integrated into the modular docking station replicates the screen on the mobile device and allows for capacitive touch such that the gestures used on the mobile device's screen will act the same way when the user touches the screen on the modular docking station.

Likewise, larger loudspeakers and a more sensitive microphone integrated into the modular docking station can transform the relatively poor speaker phone capabilities of the mobile device into a commercial grade speaker phone.

Other systems, methods, features, and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### DETAILED DESCRIPTION OF THE DRAWINGS

The components in the figures are not necessarily to scale, emphasis being placed instead upon illustrating the principles of the invention. In the figures, like reference numerals designate corresponding parts throughout the different views.

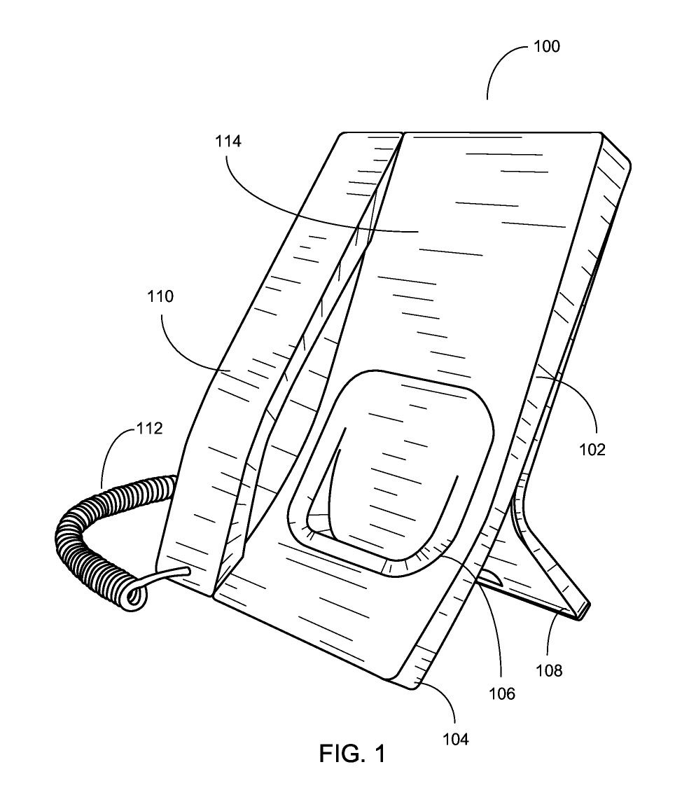

FIG. 1 is a front view illustrating an interchangeable dock mount for use in connection with a modular docking station.

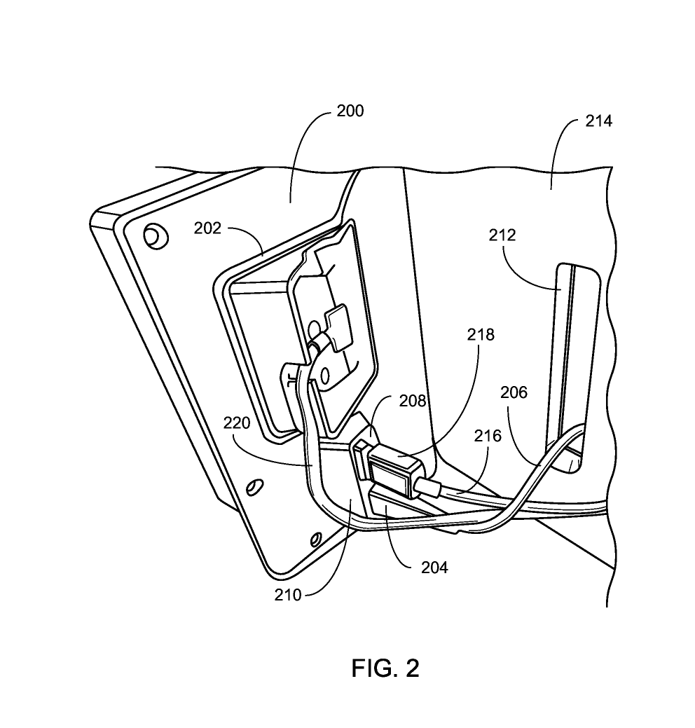

FIG. 2 is a rear view of the modular docketing station of FIG. 1.

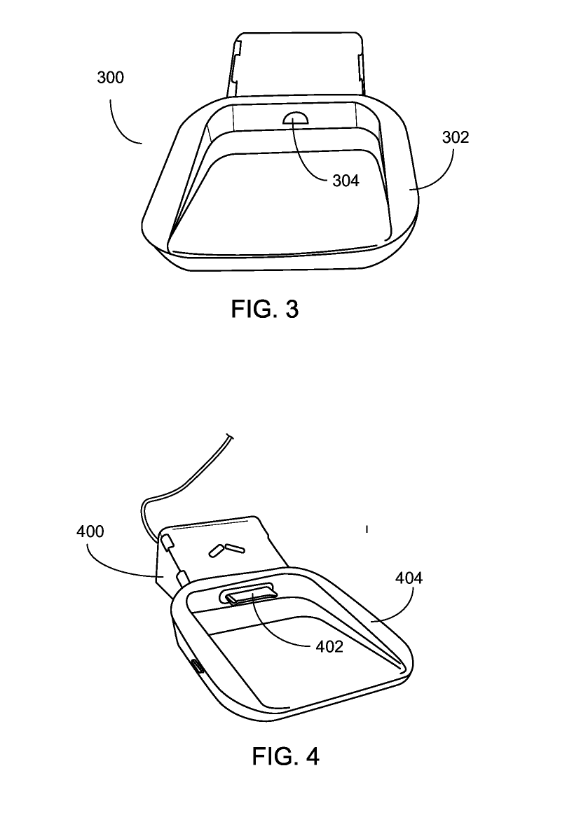

FIG. 3 is a perspective view illustrating a top view of the interchangeable dock mount of FIG. 1 with the interchangeable dock mount removed from the modular docking station.

FIG. 4 is a perspective view illustrating the interchangeable dock mount of FIG. 3.

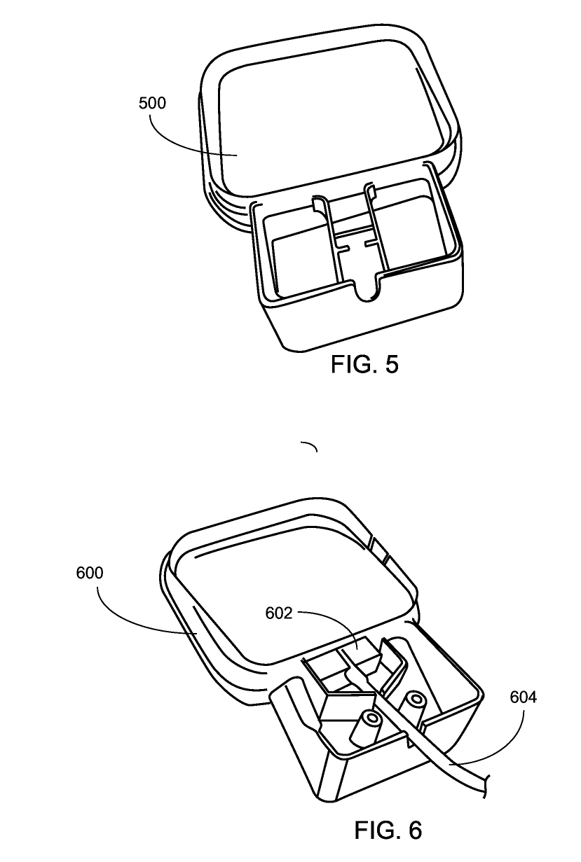

FIG. 5 is a perspective view of the rear side of the interchangeable mount dock having a back cover positioned over the electrical feed portion of the dock mount.

FIG. 6 is a perspective view of the rear side of the interchangeable mount dock illustrating the securing element and electrical interface removed from the opening of the dock mount.

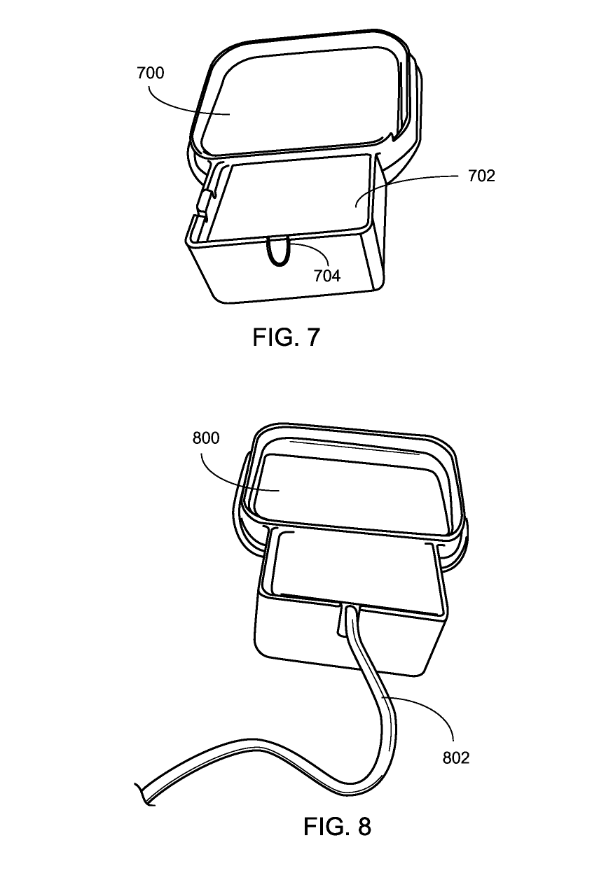

FIG. 7 is a perspective view of the rear side of the interchangeable mount dock illustrating the securing element and electrical interface removed from the opening of the dock mount.

FIG. 8 is a perspective view of the rear side of the interchangeable mount dock illustrating the securing element and electrical interface removed from the opening of the dock mount.

### DETAILED DESCRIPTION

FIG. 1 illustrates a perspective front view of an interchangeable dock mount for use in connecting mobile devices with a modular docking station 100. As illustrated in the example, a docking station 100 has a body 102 with a base 104 capable of supporting a removable and optionally, interchangeable dock mount 106 and a rear support 108. The modular docking station 100 can have a handset 110 that connects to the body 102 via a wire 112 or a wireless connection (not shown) via a wireless protocol such as Bluetooth, WiFi, etc. The handset 110 may comprise functionality so that it can allow a user to answer, dial calls, mute calls, add additional calls and end calls all from the handset thus replicating the functionality of the mobile device while the mobile device is attached to the modular docking station 100. The modular docking station 100 may also have a display screen area 114 that provides a large display screen for viewing and replicating the display screen of the mobile device.

Inclusion of a large display screen 114 integrated into the front of the modular docking stations allows users with poor eyesight to increase the size of icons, numbers and other items displayed on the mobile device screen which is substantially smaller in size. This larger screen display 114 integrated into the modular docking station 100 replicates the screen on the mobile device and allows for capacitive touch such that the gestures used on the mobile device's screen will act the same way when the user touches the screen on the modular docking station.

Likewise, larger loudspeakers (not shown) and a more sensitive microphone integrated into the modular docking station can transform the relatively poor speaker phone capabilities of the mobile device into a commercial grade speaker phone. The modular docking station 100 may also support a loudspeaker that is tuned so that the mobile device can play music at amplified volumes providing increased audio fidelity over the mobile device. In addition, inclusion of a sensitive microphone (not shown) would transform the speaker phone capabilities of the mobile device into a substantially improved performing speaker phone of commercial grade performance.

FIG. 2 illustrates a rear view of the modular docketing station 100 of FIG. 1. As illustrated, the docking station 200 includes the interchangeable dock mount 202 removably secured to the rear of the docking station 200. The rear side of the interchangeable dock mount 202 exposes an electrical interface 204 showing an electrical cable 206 for connecting to the interchangeable dock mount 202 to the same so that power can be supplied to the mobile device for recharging the mobile device's battery. Proprietary interfaces 208 associated with different mobile devices (not shown) can be interchangeably be mounted to the interchangeable dock mount 202. These proprietary interfaces (not shown) are designed so that mobile devices can connect with rechargers and other components. Unfortunately, each mobile device manufacturer has their own proprietary interface making it difficult for third party devices to connect to the mobile device. Thus, a plurality of interfaces may be included with a third party device to ensure capability with the various mobile devices that are on the market. A securing element 210 is provided to maintain the interchangeable dock mount's interface 208 with the electrical cable 204 through an opening 212 in the rear support 214.

The interchangeable dock mount 202 may also connect to a data interface wire 216 via data connector 218. This data interface wire may support via wired protocols such as Ethernet and other well-known wire based data communication protocols. Other wires may connect to internal circuit boards and provide visual lighting indicators via LED lights showing when the mobile device is recharging, when the mobile device is off or in use. The interchangeable dock mount 202 may also support traditional Plain Old Telephone Service (“POTS”) wires 220 for traditional land line service.

As illustrated in FIG. 2, the electrical interface 204 is supplied from an existing electrical cable 206 to interface with a particular electronic device (not shown). The electrical cable 206 may be a USB cable or a cable having an AC adapter at the opposing end, or both. In this manner, the electrical cable 206 may be used to communicate with the docking station, communicate with another electronic device, such as a laptop, speaker system, or television, or may be used to simply charge the electrical device through an AC adapter.

FIG. 3 illustrates the interchangeable dock mount 300 removed from the modular docking station 100. As illustrated, the interchangeable dock mount 300 includes a base portion 302 having an opening 304 for permitting the electrical interface (not shown) of the electrical cable and/or data cable to extend through the opening and couple with the mobile device adapted to rest or mount on the interchangeable dock mount 300 of the docking station 100. As illustrated in FIG. 3, the interchangeable dock mount 300 may include or be provided with a variety of interchangeable mobile device interconnects that may be proprietary to the mobile device. The interchangeable dock mount 300 has various sized openings 304 for accommodating different sized mobile device interfaces 304.

The mobile device interconnects can be stored in a compartment within the rear support 108 or within the mobile device 100 such that they can be easily inter-changed since a user may have multiple types of mobile devices and may want to inter-change them such that they can play music through the modular docking station 100 and when desired, the user can swap out the mobile device that is playing music for another device to make a call.

As shown in FIG. 4, a securing element 400 that includes a rubber grommet, plastic or metal device may be coupled to the mobile device interface 402 attached to the interchangeable dock mount 404 for removably securing a mobile device (not shown) with the mobile device interface 402 that attaches in the opening 304 of the interchangeable dock mount 404 in manner that allows the mobile device interface 402 to electrically couple with a mobile device positioned on the interchangeable dock mount 404 in the docking station 100. The securing element 400 may friction fit within the opening 304 or secured into the opening through other known means, such as a snap-lock or channel interface so that the securing element 400 forms a sandwich with the mobile device interface 402 and the interchangeable dock mount 404.

The docking station 100 can support a plurality of mobile device interfaces 406 that can connect with the securing element 400. As an alternative, the docking station may be manufactured with a plurality of interchangeable dock mounts 404 that are uniquely sized to specific and popular mobile devices. With an interchangeable dock mount 404, the dock mount 404 may come with different sized openings and different sized securing elements to accommodate and secure different sized mobile device interfaces 402 that supply electricity for recharging the mobile device's battery and for connecting into a wired internet connection. In other words, each interchangeable dock mount 404 would be designed to accommodate a different type of mobile device interface 402 and would each include custom securing elements for coupling the mobile device interface 402 to the interchangeable dock mount 404.

Alternatively, although not illustrated in the figures, the interchangeable dock mount 404 may be designed with a universal sized opening 304 for accommodating all sizes of mobile device interfaces 402. In this manner, the securing element 400 would be interchangeable with the interchangeable dock mount 404 to couple various mobile device interfaces 402 within the opening 304 of the interchangeable dock mount 404.

FIG. 5 illustrates the rear side of the interchangeable dock mount 500. FIG. 5 illustrates the backside of the interchangeable dock mount 500 where the electrical/data cord with its interface may positioned through the opening of the interchangeable dock mount 500. As illustrated by FIG. 4, a rubber securing element may be utilized to couple the electrical interface and maintain the mobile device interface within the opening 304 of the interchangeable dock mount 500.

FIG. 6 illustrates the interchangeable dock mount 600 of FIG. 4 having a back cover removed so that the electrical/data interface is exposed. As illustrated in FIG. 2, a cover may be positioned over the back of the mobile device interface 602 of the interchangeable dock mount 600 to further secure the electrical/data cable 604 to the interchangeable dock mount 600 and to help prevent the unwanted removal of the cable 604 from the interchangeable dock mount 600. The cable 604 can be positioned and griped by the interchangeable dock mount 600 so that the cable 604 and the mobile device interface 602 is secured and will not easily pull out of the interchangeable dock mount 600.

FIG. 7 illustrates the rear side of the interchangeable dock mount 700 with the securing element 702 and electrical interface and the cable removed from the opening 304 of the interchangeable dock mount 700. In FIG. 7, opening 704 of the interchangeable dock mount 700 is also visible. The docking station 100, when designed to have interchangeable dock mounts 700, will be provided with a plurality of dock mounts 700, each having different sized holes 304 for accommodating a different sized mobile device interface (not shown) for compatibility with different mobile devices (e.g., iPhone4, iPhone5, Android, Nintendo, etc.). Alternatively, a single interchangeable dock mount 700 may be provided with a universal opening and sized for a universal sized mobile device having interchangeable securing elements 702 each having different sized openings for securing to different sized mobile device interfaces.

As can be seen in FIG. 8, the dock mount 800 may be incorporated into any type of docking station 100. The cord(s) 802 may be utilized for communication directly with the docking station 100, with separate electronic devices or may simply be used as an A/C adapter for charging the mobile device on the docketing station 100. Additionally, the docking station 100 may further provide charging capabilities for the electronic device during use through a wireless power charger. In addition, the mobile device may connect via wires or wirelessly so that the mobile device can utility a more sensitive microphone or a loudspeaker that provides greater amplification for improved speaker phone calls or for the playing of music from the mobile device.

Terms such as “communicate” and “in . . . communication with” (for example, a first component “communicates with” or “is in communication with” a second component) are used herein to indicate a structural, functional, mechanical, electrical, signal, optical, magnetic, electromagnetic, ionic or fluidic relationship between two or more components or elements. As such, the fact that one component is said to communicate with a second component is not intended to exclude the possibility that additional components may be present between, and/or operatively associated or engaged with, the first and second components.

While various embodiments of the invention have been described, it will be apparent to those of ordinary skill in the art that many more embodiments and implementations are possible that are within the scope of this invention.

What is claimed is:

1. A modular docking station, comprising:
an interchangeable dock mount positioned in the modular dock station;
a mobile device interface positioned in the interchangeable dock mount that can connect to a mobile device; and
an opening in the interchangeable dock mount that supports the mobile device interface.

2. The modular docking station of claim 1 where the opening in the docking station is designed to receive a particular sized mobile device interface.

3. The modular docking station of claim 1 where the opening in the docking station is a universal in size and able to received various sized mobile device interfaces.

4. The modular docking station of claim 1 further including a securing element for supporting the mobile device interface within the opening of the modular docketing station.

5. The modular docking station of claim 4 where the securing element is a grommet sized to fit within the opening in the docketing station and further including a central hole for receiving and retaining the interface.

6. The modular docking station of claim 1 further including a display that can replicate the display of the mobile device when the mobile device is connected to the modular dockings station.

7. The modular docking station of claim 1 further including a display that can receive user commands to control the mobile device when the mobile device is connected to the modular docking station.

8. The modular docking station of claim 1 further including a loudspeaker that interfaces with the mobile device and can play music or audio from the mobile device.

9. The modular docking station of claim 1 further including a microphone that can transmit audio to the mobile device when the mobile device is connected to the modular docking station.

10. The modular docking station of claim 1 further including a storage compartment for storing mobile device interfaces specific to various mobile device manufacturers.

11. A modular docking station, comprising:
an interchangeable dock mount positioned in the modular dock station;
a mobile device interface positioned in the interchangeable dock mount that can connect to a mobile device;
an opening in the interchangeable dock mount that supports the mobile device interface;
a display positioned on the modular docking system that can replicate the display of the mobile device;
a loudspeaker integrated into the modular docking station that can generate audio sounds from the mobile device; and
a microphone in the modular docking station that can receive audio sounds and transmit them to the mobile device.

12. The modular docking station of claim 11, further comprising a storage area within the modular docking station for storing mobile device interfaces.
